(19) United States
(12) Patent Application Publication
(10) Pub. No.: US 2014/0267228 A1
(43) Pub. Date: Sep. 18, 2014

(54) MAPPING AUGMENTED REALITY EXPERIENCE TO VARIOUS ENVIRONMENTS

(71) Applicant: MICROSOFT CORPORATION, Redmond, WA (US)

(72) Inventors: Eyal Ofek, Redmond, WA (US); Ran Gal, Redmond, WA (US); Douglas Burger, Redmond, WA (US); Jaron Lanier, Berkeley, CA (US)

(73) Assignee: MICROSOFT CORPORATION, Redmond, WA (US)

(21) Appl. No.: 13/827,368

(22) Filed: Mar. 14, 2013

(51) Int. Cl. G06T 19/00

(52) U.S. Cl. CPC G06T 19/006
USPC 345/419

(57) ABSTRACT

An augmented reality (AR) experience is mapped to various environments. A three-dimensional data model that describes a scene of an environment, and a description of the AR experience, are input. The AR experience description includes a set of digital content that is to be mapped into the scene, and a set of constraints that defines attributes of the digital content when it is mapped into the scene. The 3D data model is analyzed to detect affordances in the scene, where this analysis generates a list of detected affordances. The list of detected affordances and the set of constraints are used to solve for a mapping of the set of digital content into the scene that substantially satisfies the set of constraints. The AR experience is also mapped to changing environments.

### BACKGROUND

An augmented reality (AR) can be defined as a scene of a given environment whose objects are supplemented by one or more types of digital (e.g., computer-generated) content. The digital content is composited with the objects that exist in the scene so that it appears to a user who perceives the AR that the digital content and the objects coexist in the same space. In other words, the digital content is superimposed on the scene so that the reality of the scene is artificially augmented by the digital content. As such, an AR enriches and supplements a given reality rather than completely replacing it. AR is commonly used in a wide variety of applications. Exemplary AR applications include military AR applications, medical AR applications, industrial design AR applications, manufacturing AR applications, sporting event AR applications, gaming and other types of entertainment AR applications, education AR applications, tourism AR applications and navigation AR applications.

### SUMMARY

This Summary is provided to introduce a selection of concepts, in a simplified form, that are further described hereafter in the Detailed Description. This Summary is not intended to identify key features or essential features of the claimed subject matter, nor is it intended to be used as an aid in determining the scope of the claimed subject matter.

Augmented reality (AR) experience mapping technique embodiments described herein generally involve mapping an AR experience to various environments. In one exemplary embodiment a three-dimensional (3D) data model that describes a scene of an environment is input. A description of the AR experience is also input, where this AR experience description includes a set of digital content that is to be mapped into the scene, and a set of constraints that defines attributes of the digital content when it is mapped into the scene. The 3D data model is then analyzed to detect affordances in the scene, where this analysis generates a list of detected affordances. The list of detected affordances and the set of constraints are then used to solve for a mapping of the set of digital content into the scene that substantially satisfies the set of constraints.

In another exemplary embodiment of the AR experience mapping technique described herein, an AR experience is mapped to changing environments. A 3D data model that describes a scene of an environment as a function of time is received. A description of the AR experience is also received, where this description includes a set of digital content that is to be mapped into the scene, and a set of constraints that defines attributes of the digital content when it is mapped into the scene. The 3D data model is then analyzed to detect affordances in the scene, where this analysis generates an original list of detected affordances. The original list of detected affordances and the set of constraints are then used to solve for a mapping of the set of digital content into the scene that substantially satisfies the set of constraints. Whenever changes occur in the scene, the 3D data model is re-analyzed to detect affordances in the changed scene, where this re-analysis generates a revised list of detected affordances. The revised list of detected affordances and the set of constraints are then used to solve for a mapping of the set of digital content into the changed scene that substantially satisfies the set of constraints.

### DESCRIPTION OF THE DRAWINGS

The specific features, aspects, and advantages of the augmented reality (AR) experience mapping technique embodiments described herein will become better understood with regard to the following description, appended claims, and accompanying drawings where:

FIG. 1A is a diagram illustrating a transparent perspective view of an exemplary embodiment, in simplified form, of a minimum 3D bounding box for an object and a corresponding non-minimum 3D bounding box for the object. FIG. 1B is a diagram illustrating a transparent front view of the minimum and non-minimum 3D bounding box embodiments exemplified in FIG. 1A.

FIG. 2 is a diagram illustrating an exemplary embodiment, in simplified form, of a minimum three-dimensional (3D) bounding box and a vertical binding plane thereon for a virtual basketball hoop.

FIG. 3 is a diagram illustrating an exemplary embodiment, in simplified form, of a minimum 3D bounding box and a horizontal binding plane thereon for a virtual lamp.

FIG. 4 is a flow diagram illustrating an exemplary embodiment, in simplified form, of a process for mapping an AR experience to various environments.

FIG. 5 is a flow diagram illustrating an exemplary embodiment, in simplified form, of a process for mapping an AR experience to changing environments.

FIG. 6 is a diagram illustrating one embodiment, in simplified form, of an AR experience testing technique that allows a user to visualize the degrees of freedom that are possible for the virtual objects in a given AR experience.

FIG. 7 is a diagram illustrating a simplified example of a general-purpose computer system on which various embodiments and elements of the AR experience mapping technique, as described herein, may be implemented.

### DETAILED DESCRIPTION

In the following description of augmented reality (AR) experience mapping technique embodiments (hereafter simply referred to as mapping technique embodiments) reference is made to the accompanying drawings which form a part hereof, and in which are shown, by way of illustration, specific embodiments in which the mapping technique can be practiced. It is understood that other embodiments can be utilized and structural changes can be made without departing from the scope of the mapping technique embodiments.

It is also noted that for the sake of clarity specific terminology will be resorted to in describing the mapping technique embodiments described herein and it is not intended for these embodiments to be limited to the specific terms so chosen. Furthermore, it is to be understood that each specific term includes all its technical equivalents that operate in a broadly similar manner to achieve a similar purpose. Reference herein to “one embodiment”, or “another embodiment”, or an “exemplary embodiment”, or an “alternate embodiment”, or “one implementation”, or “another implementation”, or an “exemplary implementation”, or an “alternate implementation” means that a particular feature, a particular structure, or particular characteristics described in connection with the embodiment or implementation can be included in at least one embodiment of the mapping technique. The appearances of the phrases “in one embodiment”, “in another embodiment”, “in an exemplary embodiment”, “in an alternate embodiment”, “in one implementation”, “in another implementation”, “in an exemplary implementation”, and “in an alternate implementation” in various places in the specification are not necessarily all referring to the same embodiment or implementation, nor are separate or alternative embodiments/implementations mutually exclusive of other embodiments/implementations. Yet furthermore, the order of process flow representing one or more embodiments or implementations of the mapping technique does not inherently indicate any particular order not imply any limitations of the mapping technique.

The term “AR experience” is used herein to refer to the experiences of a user while they perceive an AR. The term “AR designer” is used herein to refer to one or more people who design a given AR experience for one or more AR applications. The term “virtual object” is used herein to refer to a computer-generated object that does not exist in a real-world environment or a synthetic-world environment. The term “virtual audio source” is used herein to refer to computer-generated audio that does not exist in a real-world environment or a synthetic-world environment.

The term “sensor” is used herein to refer to any one of a variety of scene-sensing devices which can be used to generate a stream of data that represents a live scene (hereafter simply referred to as a scene) of a given real-world environment. Generally speaking and as is described in more detail hereafter, the mapping technique embodiments described herein can use one or more sensors to capture the scene, where the sensors are configured in a prescribed arrangement. In an exemplary embodiment of the mapping technique described herein, each of the sensors can be any type of video capture device, examples of which are described in more detail hereafter. Each of the sensors can also be either static (e.g., the sensor has a fixed position and a fixed rotational orientation which do not change over time) or moving (e.g., the position and/or rotational orientation of the sensor change over time). Each video capture device generates a stream of video data that includes a stream of images of the scene from the specific geometrical perspective of the video capture device. The mapping technique embodiments can also use a combination of different types of video capture devices to capture the scene.

### 1.0 Augmented Reality (AR)

As described heretofore, an AR can be defined as a scene of a given environment whose objects are supplemented by one or more types of digital content. In an exemplary embodiment of the mapping technique described herein this digital content includes one or more virtual objects which can be either video-based virtual objects, or graphics-based virtual objects, or any combination of video-based virtual objects and graphics-based virtual objects. It will be appreciated that alternate embodiments of the mapping technique are also possible where the digital content can also include either text, or one or more virtual audio sources, or a combination thereof, among other things. AR applications are becoming increasingly popular due to the proliferation of mobile computing devices that are equipped with video cameras and motion sensors, along with the aforementioned fact that an AR enriches and supplements a given reality rather than completely replacing it. Examples of such mobile computing devices include, but are not limited to, smart phones and tablet computers.

It will be appreciated that the real-world offers a wide variety of environments including, but not limited to, various types of indoor settings (such as small rooms, corridors, and large halls, among others) and various types of outdoor landscapes. It will further be appreciated that such real-world environments may change over time, where the changes in a given environment can include, but are not limited to, either a change in the number of objects that exist in the environment, or a change in the types of objects that exist in the environment, or a change in the position of one or more of the objects that exist in the environment, or a change in the spatial orientation of one or more of the objects that exist in the environment, or any combination thereof. Due to significant advancements in conventional sensor and computing technologies in recent years, a dynamic structure of these various types of real-world environments can now be built and stored online. Examples of such conventional technology advancements include, but are not limited to, the following. Advances in conventional image capture and image processing technologies allow various types of moving sensors, such as a moving video camera and/or a depth camera, among others, to be used to capture and map a given real-world environment in a live manner as the environment changes. Advances in conventional object recognition and captured geometry analysis technologies allow some of the semantics of the captured real-world environment to be understood. It will yet further be appreciated that a wide variety of synthetic-world (e.g., artificial) environments can be generated which may also change over time.

### 2.0 Mapping an AR Experience to Various Environments

Generally speaking and as is described in more detail hereafter, the mapping technique embodiments described herein involve mapping a given AR experience to various environments by using a hybrid discrete-continuous method to solve a non-convex constrained optimization function. In other words, the mapping technique embodiments can map a given AR experience to a scene of either various real-world environments or various synthetic-world environments.

The mapping technique embodiments described herein are advantageous for various reasons including, but not limited to, the following. As will be appreciated from the more detailed description that follows, the mapping technique embodiments can alter a given reality in a manner that enhances a user's current perception thereof. The mapping technique embodiments also allow an AR designer to design an AR experience that can be mapped to a wide range of different environments, where these environments can be unknown to the AR designer at the time they are designing the AR experience. The mapping technique embodiments also allow the AR designer to design an AR experience that can include a wide range of complex interactions between the virtual objects and the objects that exist in the various environments to which the AR experience will be mapped. The mapping technique embodiments can also adapt an AR experience to the aforementioned wide variety of environments that exist in both the real-world and the synthetic-world, and to scene changes in these environments, while keeping the nature of the AR experience intact. By way of example but not limitation, the mapping technique embodiments can allow an AR game that is projected on the walls of a given room to adaptively rearrange its virtual objects in other rooms that may have different dimensions, different geometries, or a different look, while still maintaining the same gaming functionality.

The mapping technique embodiments described herein are also operational with any type of AR experience (such as a video game that is to be projected onto different room geometries, or a description of one or more activities that a mobile robot is to perform in a large variety of scenes and rooms within the scenes, among many other types of AR experiences). The mapping technique embodiments are also robust, operational in any type of environment, and operational with any type of objects that may exist in a given environment. In other words, the mapping technique embodiments are effective in a large range of AR scenarios and related environments. The mapping technique embodiments can also provide a complex AR experience for any type of environment.

The mapping technique embodiments described herein can also ensure that the digital content that is mapped into a scene of an environment is consistent with the environment. By way of example but not limitation, the mapping technique embodiments can ensure that each of the virtual objects that is mapped into the scene stays within the free spatial volume in the scene and does not intersect the objects that exist in the scene (such as a floor, or walls, or furniture, among other things). The mapping technique embodiments can also ensure that the virtual objects are not occluded from a user's view by any objects that exist in the scene. The mapping technique embodiments can also ensure that the virtual objects that are mapped into the scene are consistent with each other. By way of example but not limitation, the mapping technique embodiments can ensure that the arrangement of the virtual objects is physically plausible (e.g., the mapping technique embodiments can insure that the virtual objects do not intersect each other in 3D space). The mapping technique embodiments can optionally also insure that the arrangement of the virtual objects is aesthetically pleasing to a user who perceives the augmented scene (e.g., in a situation where virtual chairs and a virtual table are added to the scene, the mapping technique embodiments can ensure that the virtual chairs are equidistant to the virtual table).

The mapping technique embodiments described herein can also ensure that a given AR experience automatically adapts to any changes in a scene of an environment to which the AR experience will be mapped. Examples of such changes may include, but are not limited to, changes in the structure of a room in the scene during the AR experience (e.g., real people in the room may move about the room, or a real object in the room such as a chair may be moved), or changes in the functionality of the AR application (e.g., the appearance of one or more new real objects in the scene, or the instantiation of additional applications that run in parallel with the AR application). The mapping technique embodiments automatically adapt the mapping of the AR experience to any such changes in the scene on-the-fly (e.g., in a live manner as such changes occur) in order to prevent breaking the “illusion” of the AR experience, or effecting the safety of the AR experience in the case where the AR application is a robotic control AR application. By way of example but not limitation, consider a gaming AR application that uses projection to extend a user's experience of playing video games from the area of a television screen to an extended area of a room that the television screen resides in. The projected content may use the objects that exist in the room to enhance the realism of the user's AR experience by using effects such as collision with the objects and casting a new illumination on the objects according to the events in a given video game. The mapping technique embodiments allow more complex effects to be included in the video game by enabling the mapping of a large number of scripted interactions to the user's environment. Additionally, rather than these interactions being scripted and mapped prior to the user playing the video game, the mapping technique embodiments allow these interactions to be mapped on-the-fly while the user is playing the video game and according to their interaction in the video game.

### 2.1 Describing an AR Experience Using Constraints

Generally speaking, rather than modeling a given AR experience directly, the mapping technique embodiments described herein allow an AR designer to describe the AR experience using both a set of digital content that is to be mapped into a scene of an environment, and a set of constraints (e.g., rules) that defines attributes of the digital content when it is mapped into the scene. As will be appreciated from the more detailed description that follows, the digital content attributes that are defined by the set of constraints express the essence of the AR experience and specify the requisite behavior of the AR experience when it is mapped into the scene. By way of example but not limitation, in a case where the set of digital content includes a virtual juggler and a virtual lion, the set of constraints may specify that the juggler is to be located in an open space in the scene and at a minimal prescribed distance from the lion so as to ensure the safety of the juggler. As is described in more detail hereafter, the set of constraints can define both geometrical attributes and non-geometrical attributes of certain items of the digital content in the set of digital content when these items are mapped into a scene of an environment.

Exemplary geometrical attributes that can be defined by the set of constraints include the position of one or more of the virtual objects in the scene, the position of one or more of the virtual audio sources in the scene, the rotational orientation of one or more of the virtual objects, the scale of one or more of the virtual objects, and the up vector of one or more of the virtual objects, among other possible geometrical attributes. By way of example but not limitation, the set of constraints can define a geometrical relationship between a given item of digital content and one or more other items of digital content (e.g., the set of constraints may specify that two or more particular virtual objects are to be collinear, or that two particular virtual objects are to be separated by a certain distance). The set of constraints can also define a geometrical relationship between a given item of digital content and one or more of the objects that exist in the scene of the environment. The set of constraints can also define a geometrical relationship between a given item of digital content and a user who perceives the AR. By way of example but not limitation, the set of constraints may specify that a given virtual object is to be positioned at a certain distance from the user in order for the virtual object to be reachable by the user. The set of constraints may also specify that a given virtual object is to be visible from the point of view of the user.

Exemplary non-geometrical attributes that can be defined by the set of constraints include the color of one or more of the virtual objects, the texture of one or more of the virtual objects, the mass of one or more of the virtual objects, the friction of one or more of the virtual objects, and the audible volume of one or more of the virtual audio sources, among other possible non-geometrical attributes. The ability to define the color and/or texture of a given virtual object is advantageous since it allows the AR designer to ensure that the virtual object will appear clearly to the user. Similarly, the ability to define the audible volume of a given virtual audio source is advantageous since it allows the AR designer to ensure that the virtual audio source will be heard by the user.

Given that Oᵢ denotes a given item of digital content that is to be mapped (in other words and as described heretofore, Oᵢ can be either a virtual object, or a virtual audio source, or text, among other things), a given AR experience description can include a set of N items of digital content that can be given by the equation Oₛₑₜ={Oᵢ}, where iε[ 1, . . . , N]. Given that Cⱼ denotes a given constraint, the AR experience description can also include a set of M constraints that can be given by the equation Cₛₑₜ={Cⱼ}, where jε[1, . . . , M]. Given that Aₖⁱ denotes a given attribute of the item of digital content Oᵢ, and given that Oᵢ is represented by a set of Kᵢ attributes, an overall set of attributes that represents the set of digital content Oₛₑₜ that is to be mapped can be given by the equation Aₛₑₜ={Aₖⁱ}, where kε[1, . . . , Kᵢ] and iε[ 1, . . . , N]. Accordingly, each of the constraints Cⱼ in the set of constraints Cₛₑₜ can be represented as a function of the attributes Aₖⁱ of one or more of the items of digital content Oᵢ in Oₛₑₜ, where this function is mapped to a real-valued score. In other words, a given constraint Cⱼ can be given by the function Cⱼ(Aₖ₍₁₎ⁱ⁽¹⁾, . . . , Aₖ₍ₗ₎^{i(l)}), where l denotes the number of attributes in Cⱼ. In an exemplary embodiment of the mapping technique described herein when Cⱼ=0 the constraint Cⱼ is satisfied. When Cⱼ has a positive value this represents some stray from the constraint Cⱼ.

Generally speaking, a given attribute Aₖⁱ can define various properties of the item of digital content Oᵢ in the AR experience when Oᵢ is mapped into a scene of an environment such as the look of Oᵢ, the physics of Oᵢ, and the behavior of Oᵢ, among others. When Oᵢ is a virtual object, examples of such properties include, but are not limited to, the position of Oᵢ in the scene, the rotational orientation of Oᵢ, the mass of Oᵢ, the scale of Oᵢ, the color of Oᵢ, the up vector of Oᵢ, the texture of Oᵢ, and the friction of Oᵢ. When Oᵢ is a virtual audio source, examples of such properties include, but are not limited to, the audible volume of Oᵢ.

As will be appreciated from the more detailed description of the mapping technique embodiments that follows, the values of some of the just described attributes Aₖⁱ of a given item of digital content Oᵢ may be preset by an AR designer when they are designing a given AR experience, while the values of others of the attributes Aₖⁱ may be determined when the AR experience is mapped to a scene of an environment. By way of example but not limitation, the scale of a certain virtual object may be preset by the AR designer, while the specific position of this virtual object in the scene may be determined when the AR experience is mapped to the scene, thus providing a user who perceives the AR with an optimal AR experience.

For the sake of simplicity, in the exemplary embodiments of the mapping technique described herein the geometry of each of the virtual objects Oᵢ in Oₛₑₜ is approximated by its minimum 3D bounding box. However, it is noted that an alternate embodiment of the mapping technique is also possible where the geometry of certain virtual objects Oᵢ can be even more accurately approximated by a plurality of minimum 3D bounding boxes having a fixed relative position. Other alternate embodiments of the mapping technique are also possible where the geometry of each of the virtual objects Oᵢ can be approximated by any other type of geometry (e.g., a spheroid, among other types of geometries), or by an implicit function (e.g., a repelling force that is lofted at the virtual object, where this force grows as you get closer to the virtual object).

The term “binding plane” is used herein to refer to a particular planar surface (e.g., a face) on the 3D bounding box of a given virtual object Oᵢ that either touches another virtual object in Oₛₑₜ, or touches a given object that exists in the scene of the environment. In other words, one particular face of the 3D bounding box for each virtual object Oᵢ will be a binding plane. The mapping technique embodiments described herein support the use of different types of 3D bounding boxes for each of the virtual objects in Oₛₑₜ, namely a conventional minimum 3D bounding box and a non-minimum 3D bounding box. A non-minimum 3D bounding box for Oᵢ is herein defined to have the following geometrical relationship to the minimum 3D bounding box of Oᵢ. The coordinate axes of the non-minimum 3D bounding box for Oᵢ are aligned with the coordinate axes of the minimum 3D bounding box of Oᵢ. The center point of the non-minimum 3D bounding box for Oᵢ is located at the center point of the minimum 3D bounding box of Oᵢ. The size of the non-minimum 3D bounding box for Oᵢ is larger than the size of the minimum 3D bounding box of Oᵢ such that each of the faces of the non-minimum 3D bounding box is parallel to and a prescribed distance away from its corresponding face on the minimum 3D bounding box.

FIG. 1A illustrates a transparent perspective view of an exemplary embodiment, in simplified form, of a minimum 3D bounding box for an object and a corresponding non-minimum 3D bounding box for the object. FIG. 1B illustrates a transparent front view of the minimum and non-minimum 3D bounding box embodiments exemplified in FIG. 1A. As exemplified in FIGS. 1A and 1B, the coordinate axes (not shown) of the minimum 3D bounding box 100 of the object (not shown) are aligned with the coordinate axes (also not shown) of the non-minimum 3D bounding box 102 for the object. The center point 104 of the non-minimum 3D bounding box 102 is located at the center point 104 of the minimum 3D bounding box 100. The size of the non-minimum 3D bounding box 102 is larger than the size of the minimum 3D bounding box 100 such that each of the faces of the non-minimum 3D bounding box 102 is parallel to and a prescribed distance D away from its corresponding face on the minimum 3D bounding box 100.

Given the foregoing, it will be appreciated that the binding plane of a virtual object Oᵢ can be thought of as a unary constraint for Oᵢ. Using the minimum 3D bounding box of Oᵢ will result in Oᵢ being directly attached to either another virtual object in Oₛₑₜ, or a given object that exists in the scene of the environment. In other words, the binding plane of Oᵢ will touch the offering plane with which this binding plane is associated. Using a non-minimum 3D bounding box for Oᵢ will result in Oᵢ being located in open space the prescribed distance from either another virtual object in Oₛₑₜ^{,} or a given object that exists in the scene. In other words, the binding plane of Oᵢ will be separated from the offering plane with which this binding plane is associated by the aforementioned prescribed distance such that Oᵢ will appear to a user to be “floating” in open space in the scene.

The term “offering plane” is used herein to refer to a planar surface that is detected on either a given object that exists in the scene, or a given virtual object that is already mapped into the scene. A given offering plane can be associated with a given virtual object Oᵢ via a given constraint Cⱼ. The mapping technique embodiments described herein represent offering planes as 3D polygons. As is described in more detail hereafter, the binding plane of Oᵢ represents an interface between Oᵢ and the environment. By way of example but not limitation, the base of a virtual object that is to be free-standing in the environment (e.g., the base of the virtual lamp described hereafter) may have to be supported by some horizontal offering plane in the environment that can support the weight of the virtual object. The back of a virtual object that is to be supported by a vertical structure in the environment (e.g., the back of the virtual basketball hoop described hereafter) may have to be directly attached to some vertical offering plane in the environment that can support the weight of the virtual object.

FIG. 2 illustrates an exemplary embodiment, in simplified form, of a minimum 3D bounding box and a vertical binding plane thereon for a virtual basketball hoop. As exemplified in FIG. 2, the minimum 3D bounding box 204 for the virtual basketball hoop 200 includes one vertical binding plane 202 that could be directly attached to an appropriate vertical offering plane in a scene of a given environment. By way of example but not limitation, this vertical offering plane could be a wall in the scene to which the basketball hoop is directly attached. As such, a virtual object that is to be supported by a vertical structure in an AR will generally have a vertical binding plane.

FIG. 3 illustrates an exemplary embodiment, in simplified form, of a minimum 3D bounding box and a horizontal binding plane thereon for a virtual lamp. As exemplified in FIG. 3, the minimum 3D bounding box 304 for the virtual lamp 300 includes one horizontal binding plane 302 that could be supported by an appropriate horizontal offering plane in a scene of a given environment. By way of example but not limitation, this horizontal offering plane could be a floor in the scene on top of which the lamp stands. As such, a virtual object that is to stand on a supporting horizontal structure in an AR will generally have a horizontal binding plane which is the base of the virtual object.

In an exemplary embodiment of the mapping technique described herein the coordinate system of each of the virtual objects Oᵢ in Oₛₑₜ is defined to originate in the center of the binding plane of Oᵢ and is defined to be parallel to the edges of the 3D bounding box for Oᵢ, where the z axis of this coordinate system is defined to be orthogonal to the binding plane.

### 2.2 AR Experience Scripting Language

In an exemplary embodiment of the mapping technique described herein a simple, declarative scripting language is used to describe a given AR experience. In other words, an AR designer can use the scripting language to generate a script that describes the set of digital content Oₛₑₜ that is to be mapped into a scene of an environment, and also describes the set of constraints Cₛₑₜ that defines attributes of the items of digital content when they are mapped into the scene. This section provides a greatly simplified description of this scripting language.

A given virtual object Oᵢ can be described by its 3D bounding box dimensions (Oᵢ.bx, Oᵢ.by, Oᵢ.bz) which are defined in the local coordinate system of Oᵢ around its center point (Oᵢ.x, Oᵢ.y, Oᵢ.z). bx denotes the size of the bounding box along the x axis of this coordinate system. by denotes the size of the bounding box along the y axis of this coordinate system. bz denotes the size of the bounding box along the z axis of this coordinate system. The center point (Oᵢ.x, Oᵢ.y, Oᵢ.z) of Oᵢ is used to define the position of Oᵢ in the scene to which Oᵢ is being mapped.

For a virtual object Oᵢ that is to be supported by an appropriate horizontal offering plane in the scene of the environment (e.g., the virtual lamp exemplified in FIG. 3), the lower horizontal face of the 3D bounding box of Oᵢ (which can be denoted by the equation Z=−Oᵢ.bz/2) will be the binding plane of Oᵢ. The scripting language makes it possible to limit the types of offering planes to which such a virtual object may be attached by using the following exemplary command:

Name:=Object1([bx,by,bz],HORIZONTAL); (1)

where this command (1) specifies that the virtual object Object1 has a width of bx, a depth of by, and a height of bz, and Object1 is to be assigned (e.g., attached) to some horizontal offering plane in the scene. Similarly, for a virtual object Oᵢ that is to be supported by an appropriate vertical offering plane in the scene (e.g., the virtual basketball hoop exemplified in FIG. 2), one of the vertical faces of the 3D bounding box of Oᵢ will be the binding plane of Oᵢ. The scripting language makes it possible to limit the types of offering planes to which such a virtual object may be attached by using the following exemplary command:

Name:=Object2([bx,by,bz],VERTICAL); (2)

where this command (2) specifies that the virtual object Object2 has a width of bx, a depth of by, and a height of bz, and Object2 is to be assigned (e.g., attached) to some vertical offering plane in the scene.

The scripting language uses the set of constraints Cₛₑₜ that, as described heretofore, can provide for a rich description of the geometrical and non-geometrical attributes of each of the items of digital content in Oₛₑₜ when they are mapped into a scene of an environment. It will be appreciated that the constraints vocabulary can be easily expanded to include additional geometrical and non-geometrical digital content attributes besides those that are described herein. The scripting language makes it possible to set constraints relating to a given item of digital content by using an Assert(Boolean Expression) command, where the Boolean Expression defines the constraints.

### 2.3 Binding Plane Constraints

Generally speaking and as is appreciated in the arts of industrial design, human-computer interaction, and artificial intelligence, among others, an affordance is an intrinsic property of an object, or an environment, that allows an action to be performed with the object/environment. Accordingly, the term “affordance” is used herein to refer to any one of a variety of features that can be detected in a scene of a given environment. In other words, an affordance is any attribute of the scene that can be detected. As is described in more detail hereafter, the mapping technique embodiments described herein support the detection and subsequent use of a wide variety of affordances including, but not limited to, geometrical attributes of the scene, non-geometrical attributes of the scene, and any other detectable attribute of the scene.

Exemplary geometrical attributes of the scene that can be detected and used by the mapping technique embodiments described herein include offering planes that exist in the scene, and corners that exist in the scene, among others. The mapping technique embodiments can detect and use any types of offering planes in the scene including, but not limited to, vertical offering planes (such as the aforementioned wall to which the virtual basketball hoop of FIG. 2 is directly attached, among other things), horizontal offering planes (such as the aforementioned floor on top of which the virtual lamp of FIG. 3 stands, among other things), and diagonal offering planes. Exemplary non-geometrical attributes of the scene that can be detected and used by the mapping technique embodiments include specific known objects that are recognized in the scene (such as chairs, people, tables, specific faces, text, among other things), illuminated areas that exist in the scene, a pallet of colors that exists in the scene, and a pallet of textures that exists in the scene, among others.

Exemplary geometrical attributes of the scene that can be detected and used by the mapping technique embodiments described herein also include spatial volumes in the scene that are occupied by objects that exist in the scene. These occupied spatial volumes can be thought of as volumes of mass. In one embodiment of the mapping technique the geometry of each occupied spatial volume in the scene is approximated by its minimum 3D bounding box. However, it is noted that an alternate embodiment of the mapping technique is also possible where the geometry of certain occupied spatial volumes in the scene can be even more accurately approximated by a plurality of minimum 3D bounding boxes having a fixed relative position. Other alternate embodiments of the mapping technique are also possible where the geometry of each occupied spatial volume in the scene can be represented in various other ways such as an array of voxels, or an octree, or a binary space partitioning tree, among others. The detection of occupied spatial volumes in the scene is advantageous since it allows constraints to be defined that specify spatial volumes in the scene where the items of digital content cannot be positioned. Such constraints can be used to prevent the geometry of virtual objects from intersecting the geometry of any objects that exist in the scene.

As is described in more detail hereafter, the mapping technique embodiments described herein generate a list of affordances that are detected in a scene of a given environment. It will be appreciated that detecting a larger number of different types of features in the scene results in a richer list of affordances, which in turn allows a more elaborate set of constraints Cₛₑₜ to be defined. For the sake of simplicity, the mapping technique embodiments described hereafter assume that just offering planes are detected in the scene so that each of the affordances in the list of affordances will be either a vertical offering plane, or a horizontal offering plane, or a diagonal offering plane. It is noted however that the mapping technique embodiments support the use of any combination of any of the aforementioned types of affordances.

The term “binding plane constraint” is used herein to refer to a constraint for the binding plane of a given virtual object Oᵢ in Oₛₑₜ. Given the foregoing, it will be appreciated that a binding plane constraint for Oᵢ can define either the geometrical relationship between the binding plane of Oᵢ and one or more other virtual objects in Oₛₑₜ, or the geometrical relationship between the binding plane of Oᵢ and some affordance in the list of affordances. In the case where a binding plane constraint for Oᵢ defines the geometrical relationship between the binding plane of Oᵢ and one or more other virtual objects in Oₛₑₜ, this binding plane constraint can be expressed using the aforementioned function Cⱼ(Aₖ₍₁₎ⁱ⁽¹⁾, . . . , Aₖ₍ₗ₎^{i(l)}). The expression of a binding plane constraint for Oᵢ that defines the geometrical relationship between the binding plane of Oᵢ and some affordance in the list of affordances is described in more detail hereafter.

Generally speaking, for a given AR experience the binding plane of each of the virtual objects Oᵢ in Oₛₑₜ is associated with some supporting offering plane in the scene. In the case where the 3D bounding box of a given virtual object Oᵢ is a minimum 3D bounding box, an association between the binding plane of Oᵢ and a given offering plane results in Oᵢ being directly attached to the offering plane such that Oᵢ touches the offering plane as described heretofore. However, it will be appreciated that it might not be possible to associate some of the offering planes that are detected in the scene with the binding plane of Oᵢ. By way of example but not limitation and referring again to FIG. 3, if Oᵢ is the virtual lamp 300 that has a horizontal binding plane 302, it might be that this binding plane may just be associated with horizontal offering planes in the scene in order to support the virtual lamp in a stable manner. Similarly and referring again to FIG. 2, if Oᵢ is the virtual basketball hoop 200 that has a vertical binding plane 202, it might be that this binding plane may just be associated with vertical offering planes in the scene in order to support the virtual basketball hoop in a stable manner.

Given the foregoing, and given that Bₗ denotes a binding plane constraint for a given virtual object Oᵢ in Oₛₑₜ, and also given that {OfferingPlanes} denotes a prescribed set of one or more of the offering planes that is detected in the scene, the AR experience can include a set of T binding plane constraints that can be given by the following equation:

Bₛₑₜ={Bₗ} where l=[1, . . . ,T] and Bⱼ(Oᵢ;{OfferingPlanes})=0. (3)

In other words, the binding plane of Oᵢ can be associated with one of a group of possible offering planes that are detected in the scene.

When a given virtual object is mapped into a scene of an environment, the mapping technique embodiments described herein can provide various ways to ensure that the location in the scene where the virtual object is positioned has sufficient open space to fit the virtual object. By way of example but not limitation, consider a situation where the scene includes a floor with a table lying on a portion of the floor, and an AR experience includes the virtual lamp exemplified in FIG. 3, where the height of the virtual lamp is greater than the height of the table so that the virtual lamp will not fit beneath the table. The mapping technique embodiments can prevent the virtual lamp from being positioned beneath the table in the following exemplary ways. A constraint can be defined which specifies that the virtual lamp is not to intersect any offering plane in the scene. Given that the floor is detected as an offering plane, this offering plane can be modified per the geometry of the virtual lamp, where the modified offering plane is a subset of the original offering plane where there is sufficient open space to fit the geometry of the virtual lamp.

### 2.4 Process for Mapping an AR Experience to Various Environments

FIG. 4 illustrates an exemplary embodiment, in simplified form, of a process for mapping an AR experience to various environments. As exemplified in FIG. 4, the process starts in block 400 with inputting a 3D data model that describes a scene of an environment. A description of the AR experience is then input, where this description includes a set of digital content that is to be mapped into the scene, and a set of constraints that defines attributes of the digital content when it is mapped into the scene (block 402). As described heretofore, the environment can be either a real-world environment or a synthetic-world environment. The 3D data model can be generated in various ways including, but not limited to, the following.

In the case where the environment to which the AR experience is being mapped is a synthetic-world environment, a scene of the synthetic-world environment can be generated using one or more computing devices. In other words, these computing devices can directly generate a 3D data model (sometimes referred to as a computer-aided design (CAD) model) that describes the scene of the synthetic-world environment as a function of time. The mapping technique embodiments described herein support any of the conventional CAD model formats.

In the case where the environment to which the AR experience is being mapped is a real-world environment, a scene of the real-world environment can be captured using one or more sensors. As described heretofore, each of these sensors can be any type of video capture device. By way of example but not limitation, a given sensor can be a conventional visible light video camera that generates a stream of video data which includes a stream of color images of the scene. A given sensor can also be a conventional light-field camera (also known as a “plenoptic camera”) that generates a stream of video data which includes a stream of color light-field images of the scene. A given sensor can also be a conventional infrared structured-light projector combined with a conventional infrared video camera that is matched to the projector, where this projector/camera combination generates a stream of video data that includes a stream of infrared images of the scene. This projector/camera combination is also known as a “structured-light 3D scanner”. A given sensor can also be a conventional monochromatic video camera that generates a stream of video data which includes a stream of monochrome images of the scene. A given sensor can also be a conventional time-of-flight camera that generates a stream of video data which includes both a stream of depth map images of the scene and a stream of color images of the scene. A given sensor can also employ conventional LIDAR (light detection and ranging) technology that illuminates the scene with laser light and generates a stream of video data which includes a stream of back-scattered light images of the scene.

Generally speaking, a 3D data model that describes the captured scene of the real-world environment as a function of time can be generated by processing the one or more streams of video data that are generated by the just described one or more sensors. More particularly, and by way of example but not limitation, the streams of video data can first be calibrated as necessary, resulting in streams of video data that are temporally and spatially calibrated. It will be appreciated that this calibration can be performed using various conventional calibration methods that depend on the particular number and types of sensors that are being used to capture the scene. The 3D data model can then be generated from the calibrated streams of video data using various conventional 3D reconstruction methods that also depend on the particular number and types of sensors that are being used to capture the scene, among other things. It will thus be appreciated that the 3D data model that is generated can include, but is not limited to, either a stream of depth map images of the scene, or a stream of 3D point cloud representations of the scene, or a stream of mesh models of the scene and a corresponding stream of texture maps which define texture data for each of the mesh models, or any combination thereof.

Referring again to FIG. 4, after the 3D data model that describes the scene and the description of the AR experience have been input (blocks 400 and 402), the 3D data model is then analyzed to detect affordances in the scene, where this analysis generates a list of detected affordances (block 404). Various types of affordances that can be detected in the scene are described heretofore. As will be appreciated from the mapping technique embodiments described herein, although the list of detected affordances will generally be a simpler model of the scene than the 3D data model that describes the scene, the list of detected affordances represents enough of the scene's attributes to support finding a mapping of the set of digital content into the scene that substantially satisfies (e.g., substantially complies with) the set of constraints. Various methods can be used to analyze the 3D data model to detect affordances in the scene. By way of example but not limitation, in the aforementioned case where the 3D data model includes a stream of depth map images of the scene, affordances in the scene can be detected by using a conventional depth map analysis method. In the aforementioned case where the 3D data model includes a stream of 3D point cloud representations of the scene, affordances in the scene can be detected by applying a conventional Hough transform to the 3D point cloud representations.

Referring again to FIG. 4, after the list of detected affordances has been generated (block 404), the list of detected affordances and the set of constraints are then used to solve for (e.g., find) a mapping of the set of digital content into the scene that substantially satisfies the set of constraints (block 406). In other words, the mapping technique embodiments described herein calculate values for one or more attributes of each of the items of digital content that substantially satisfy each of the constraints that are associated with the item of digital content (e.g., the mapping solution can specify an arrangement of the set of digital content in the scene that substantially satisfies the set of constraints). Accordingly, when the set of constraints includes a binding plane constraint for a given virtual object in the set of digital content, the mapping solution will select an offering plane from the list of detected affordances that substantially satisfies the binding plane constraint, and will assign the virtual object's binding plane to the selected offering plane. Various methods can be used to solve for a mapping of the set of digital content into the scene that substantially satisfies the set of constraints, examples of which are described in more detail hereafter. It is noted that the mapping technique embodiments can use the set of constraints to map the set of digital content into any scene of any type of environment.

Once the mapping of the set of digital content into the scene that substantially satisfies the set of constraints has been solved for, the values that were calculated for the attributes of the items of digital content can be input to a given AR application, which can use these values to render the AR experience. By way of example but not limitation, a gaming AR application may render the virtual objects on top of a video of a scene of a prescribed environment, where each of the rendered virtual objects will be placed at a location in the environment, and will have dimensions and a look, that is specified by the calculated attribute values. A robotic control AR application may guide a mobile robot to different positions in a prescribed environment that are specified by the calculated attribute values, where the robot may drop objects at certain of these positions, and may charge itself using wall sockets that are detected at others of these positions.

Referring again to FIG. 4, after the mapping of the set of digital content into the scene that substantially satisfies the set of constraints has been solved for (block 406), the mapping can be used in various ways. By way of example but not limitation, the mapping can optionally be stored for future use (block 408). The mapping can also optionally be used to render an augmented version of the scene (block 410). The augmented version of the scene can then optionally be stored for future use (block 412), or it can optionally be displayed for viewing by a user (block 414).

It will be appreciated that in many AR applications, changes in the scene into which the set of digital content is mapped can necessitate that the mapping be updated. By way of example but not limitation, in the case where the mapping includes a virtual sign that is directly attached to a door in the scene and the door is currently closed, if the door is subsequently opened then the virtual sign may need to be relocated in the scene. Similarly, in the case where the mapping includes a virtual character that is projected on a wall of a room in the scene, if a real person subsequently steps into the room and stands in the current location of the virtual character then the virtual character may need to be relocated in the scene. It will also be appreciated that when the scene changes, there can be a loss of some of the affordances that were previously detected in the scene, and new affordances can be introduced into the scene that were not previously detected. The mapping may also have to be updated in the case where the AR application necessitates that one or more additional virtual objects be mapped into the scene, or in the case where two different AR applications are running in parallel and one of the AR applications needs resources from the other AR application. Generally speaking, the mapping technique embodiments described herein are applicable to a dynamic (e.g., changing) environment. In other words and as described heretofore, the mapping technique embodiments can automatically adapt the mapping of the AR experience to any changes in the scene that may occur over time.

FIG. 5 illustrates an exemplary embodiment, in simplified form, of a process for mapping an AR experience to changing environments. As exemplified in FIG. 5, the process starts in block 500 with receiving a 3D data model that describes a scene of an environment as a function of time. A description of the AR experience is then received, where this description includes a set of digital content that is to be mapped into the scene, and a set of constraints that defines attributes of the digital content when it is mapped into the scene (block 502). The 3D data model is then analyzed to detect affordances in the scene, where this analysis generates an original list of detected affordances (block 504). The original list of detected affordances and the set of constraints are then used to solve for a mapping of the set of digital content into the scene that substantially satisfies the set of constraints (block 506). Whenever changes occur in the scene (block 508, Yes), the 3D data model will be re-analyzed to detect affordances in the changed scene, where this re-analysis generates a revised list of detected affordances (block 512). The revised list of detected affordances and the set of constraints will then be used to solve for a mapping of the set of digital content into the changed scene that substantially satisfies the set of constraints (block 514). In an exemplary embodiment of the mapping technique described herein, the mapping of the set of digital content into the changed scene includes a re-mapping of just the attributes of the digital content that is affected by the differences between the original list of detected affordances and the revised list of detected affordances.

### 2.5 Solving for Mapping

This section provides a more detailed description of various methods that can be used to solve for a mapping of the set of digital content Oₛₑₜ into a scene of an environment that substantially satisfies the set of constraints Cₛₑₜ. In an exemplary embodiment of the mapping technique described herein the cost of a given mapping of Oₛₑₜ into the scene is represented by a cost function E that can be given by the following equation:

$$E = {\sum }_{j = 1}^{M} {w}_{j} * {C}_{j} , \qquad ( 4 )$$

where wⱼ is a pre-defined weight that is assigned to the constraint Cⱼ. In other words, the cost of the mapping is the weighted average of the real-valued scores of each of the constraints Cⱼ in Cₛₑₜ. Accordingly, the cost function E evaluates the degree to which a given mapping of Oₛₑₜ into the scene satisfies Cₛₑₜ. It will be appreciated that the closer E is to zero, the closer the mapping of Oₛₑₜ into the scene is to satisfying Cₛₑₜ. When E=0, the mapping of Oₛₑₜ into the scene satisfies Cₛₑₜ.

In one embodiment of the mapping technique described herein a theorem prover (such as the conventional Z3 high performance theorem prover, among others) can be used to solve for a mapping of the set of digital content into the scene that satisfies the set of constraints (assuming such a mapping exists).

In another embodiment of the mapping technique described herein various cost function optimization methods can be used to solve for a mapping of the set of digital content into the scene that minimizes the cost function E by approximating the set of constraints. Exemplary cost function optimization methods are described in more detail hereafter. This particular embodiment is hereafter simply referred to as the cost function optimization embodiment of the mapping technique. The cost function optimization embodiment of the mapping technique is advantageous in that it allows soft constraints to be specified for an AR experience. Soft constraints can be useful in various situations such as when an AR designer wants a given virtual object to be as large as possible within a scene of a given environment. By way of example but not limitation, consider a situation where the AR designer wants a television screen to be placed on a room wall, where the size of the television screen is to be the largest that the room wall will support, up to a prescribed maximum size. In this situation the AR designer can generate a constraint specifying that the size of television screen is to be scaled to the largest size possible but not larger than the prescribed maximum size. The cost function optimization embodiment will solve for a mapping of the television screen such that its size is as close as possible to that which is specified by the constraint. If no room wall as big as the prescribed maximum size is detected in the scene, then the minimum E will be greater than zero.

In one implementation of the cost function optimization embodiment of the mapping technique described herein the cost function optimization method is a conventional simulated annealing method with a Metropolis-Hastings state-search step. In another implementation of the cost function optimization embodiment the cost function optimization method is a Markov chain Monte Carlo sampler method (hereafter simply referred to as the sampler method). As will be appreciated from the more detailed description of the sampler method that follows, the sampler method is effective at finding satisfactory mapping solutions when the cost function E is highly multi-modal.

It will be appreciated that each of the attributes of each of the items of digital content in the set of digital content that is to be mapped has a finite range of possible values. Regarding attributes that define the position of digital content in the scene into which the digital content is being mapped, and by way of example but not limitation, consider the case where a given attribute of a given virtual object specifies that the virtual object is to lie/stand on a horizontal structure in the scene. In this case possible positions for the virtual object can be the union of all of the horizontal offering planes that are detected in the scene. For the sake of efficiency and as is described in more detail hereafter, the sampler method uses discrete locations on a 3D grid to approximate the positioning of digital content in the scene. Such an approximation is advantageous since it enables easy uniform sampling of candidate positions for each of the items of digital content with minimal bias, and it also enables fast computation of queries such as those that are looking for intersections between the geometry of virtual objects and the geometry of any objects that exist in the scene.

Regarding attributes that define the rotational orientation of virtual objects in the scene into which the virtual objects are being mapped, and by way of example but not limitation, consider the case where a given virtual object is mapped to a given offering plane that is detected in the scene and the binding plane of the virtual object is directly attached to the offering plane. In this case the virtual object's rotational orientation about the x and y axes is defined by the mapping, and just the virtual object's rotational orientation about the z axis may be defined by a constraint in the set of constraints. In an exemplary embodiment of the mapping technique described herein, constraints that define rotational orientation attributes can be assigned a value between zero degrees and 360 degrees. Constraints that define others of the aforementioned exemplary types of virtual object attributes (such as mass, scale, color, texture, and the like) and the aforementioned exemplary types of virtual audio source attributes (such as audible volume, and the like), can be specified to be within a finite range between a minimum value and a maximum value, thus enabling easy uniform sampling of the parameter space.

The following is a general description, in simplified form, of the operation of the sampler method. First, a 3D grid having a prescribed resolution is established, where this resolution is generally chosen such that the mapping that is being solved for has sufficient resolution for the one or more AR applications in which the mapping may be used. In an exemplary embodiment of the sampler method, a resolution of 2.5 centimeters is used for the 3D grid. For each of the detected affordances in the list of detected affordances, all locations on the 3D grid that lie either on or within a prescribed small distance from the surface of the detected affordance are identified, and each of these identified locations is stored in a list of possible digital content locations.

The mapping of a given item of digital content into the scene involves assigning a value to each of the attributes of the item that is defined in the set of constraints, where each such value assignment can be represented as a state in parameter space. The sampler method samples this parameter space using the following random walk method. Starting from a random generated state, a random value is assigned to each of the attributes that is defined in the set of constraints. The cost function E is then evaluated and its value is assigned to be a current cost. A new random value is then assigned to each of the attributes that is defined in the set of constraints. E is then re-evaluated and if its new value is less than the current cost, then this new value is assigned to be the current cost. This process of assigning a random value to each of the attributes and then re-evaluating E is repeated for a prescribed number of iterations. If the current cost is less than or equal to a prescribed cost threshold, then the values of the attributes that are associated with the current cost are used as the mapping. If the current cost is still greater than the prescribed cost threshold, the process of assigning a random value to each of the attributes and then re-evaluating E is again repeated for the prescribed number of iterations.

As described heretofore, changes in the scene into which the digital content is mapped can result in the loss of some of the affordances that were previously detected in the scene, and can also result in the introduction of new affordances into the scene that were not previously detected. These changes in the scene affordances may cause a new mapping of some of the items of digital content in the set of digital content to be solved for. However, the mapping technique embodiments described herein generally attempt to keep as much consistency as possible in the mapping of the set of digital content over time. In other words, items of digital content that can maintain their current mapping without increasing the value of the cost function E beyond a prescribed amount will generally maintain their current mapping. To accomplish this, the mapping technique embodiments can add the distance of the new mapping from the current mapping to E, where this distance is weighted by an importance factor that represents the importance of keeping consistency in the mapping.

### 3.0 Additional Embodiments

In conventional media creation processes such as painting, sculpting, 3D modeling, video game creation, film shooting, and the like, a single “final product” (e.g., a painting, a sculpture, a 3D model, a video game, a film, and the like) is produced. The creator(s) of the final product can analyze it in various ways to determine whether or not the experience it provides conveys their intentions. In contrast to these conventional media creation processes and as described heretofore, the mapping technique embodiments described herein provide for the mapping of a given AR experience to a wide variety of different scenes in a wide variety of different real-world and synthetic-world environments. Using the painting analogy, rather than producing a painting of a single scene of a single environment, the mapping technique embodiments use a set of constraints that define how a painting is to be produced, regardless of which scene of which environment will be painted. As such, the mapping technique embodiments do not produce just a single final product. Rather, the mapping technique embodiments can produce a large number of different final products.

The mapping technique embodiments described herein also involve various methods for debugging and quality assurance testing the mapping of a given AR experience across a wide variety of different scenes in a wide variety of different real-world and synthetic-world environments. These debugging and quality assurance testing methods are hereafter referred to as AR experience testing techniques. Exemplary AR experience testing technique embodiments are described in more detail hereafter. These testing technique embodiments are advantageous for various reasons including, but not limited to, the following. As will be appreciated from the more detailed description that follows, the testing technique embodiments provide a user (such as an AR designer or a quality assurance tester, among other types of people) a way to ensure a desired level of quality in the AR experience without having to view the AR experience in each and every scene/environment that the AR experience can be mapped to. The testing technique embodiments also allow the user to ensure that the AR experience is robust for a large domain of scenes/environments.

FIG. 6 illustrates one embodiment, in simplified form, of an AR experience testing technique that allows a user to visualize the degrees of freedom that are possible for the virtual objects in a given AR experience. As exemplified in FIG. 6, the AR experience 606 includes a virtual table 600, a virtual notebook computer 602, and a virtual cat 604. Generally speaking, the AR experience 606 is displayed under motion. More particularly, each possible degree of freedom of the table 600 is displayed as a limited motion exemplified by arrows 608 and 610. Each possible degree of freedom of the computer 602 is displayed as a limited motion exemplified by arrows 612 and 614. Each possible degree of freedom of the cat 604 is displayed as a limited motion exemplified by arrows 616 and 618. This dynamic display of the AR experience 606 allows the user to determine whether or not the set of constraints that defines attributes of the table 600, computer 602 and cat 604 appropriately represent the AR designer's knowledge and intentions for the AR experience (e.g., if additional constraints need to be added to the set of constraints, or if one or more existing constraints need to be modified). By way of example but not limitation, if the set of constraints specifies that the computer 602 is to be positioned on top of the table 600, it is natural to expect that the computer will move with the table if the table is moved. However, if the AR designer did not generate a constraint specifying that the computer 602 will move with the table 600 if the table is moved (e.g., the AR designer forgot this constraint since it seemed obvious), then the computer may become separated from the table if the table is moved. It will be appreciated that rather than using arrows to indicate the possible degrees of freedom of the virtual objects, parts of the AR experience could be colored based on their relative possible degrees of freedom.

Another AR experience testing technique embodiment allows a user to visualize the mapping of a given AR experience to a set of representative scenes which are selected from a database of scenes. The selection of the representative scenes from the database can be based on various criteria. By way of example but not limitation, the selection of the representative scenes from the database can be based on the distribution of types of scenes in the database that represent the existence of such rooms in the real-world. The selection of the representative scenes from the database can also be based on variations that exist in the mapping of the AR experience to the different scenes in the database. It will be appreciated that it is advantageous to allow the user to visualize scenes that have different mappings, even if the scenes themselves might be similar. The selection of the representative scenes from the database can also be based on finding mappings of the AR experience that are different from all the other mappings, and are more sensitive to scene changes. The sensitivity to scene changes can be estimated by perturbating the parameters of the scenes (e.g., the range of expected rooms, among other parameters) a prescribed small amount and checking for the existence of a mapping solution.

While the mapping technique has been described by specific reference to embodiments thereof, it is understood that variations and modifications thereof can be made without departing from the true spirit and scope of the mapping technique. It is noted that any or all of the aforementioned embodiments can be used in any combination desired to form additional hybrid embodiments. Although the mapping technique embodiments have been described in language specific to structural features and/or methodological acts, it is to be understood that the subject matter defined in the appended claims is not necessarily limited to the specific features or acts described heretofore. Rather, the specific features and acts described heretofore are disclosed as example forms of implementing the claims.

### 4.0 Exemplary Operating Environments

The mapping technique embodiments described herein are operational within numerous types of general purpose or special purpose computing system environments or configurations. FIG. 7 illustrates a simplified example of a general-purpose computer system on which various embodiments and elements of the mapping technique, as described herein, may be implemented. It is noted that any boxes that are represented by broken or dashed lines in FIG. 7 represent alternate embodiments of the simplified computing device, and that any or all of these alternate embodiments, as described below, may be used in combination with other alternate embodiments that are described throughout this document.

For example, FIG. 7 shows a general system diagram showing a simplified computing device 700. Such computing devices can be typically be found in devices having at least some minimum computational capability, including, but not limited to, personal computers (PCs), server computers, handheld computing devices, laptop or mobile computers, communications devices such as cell phones and personal digital assistants (PDAs), multiprocessor systems, microprocessor-based systems, set top boxes, programmable consumer electronics, network PCs, minicomputers, mainframe computers, and audio or video media players.

To allow a device to implement the mapping technique embodiments described herein, the device should have a sufficient computational capability and system memory to enable basic computational operations. In particular, as illustrated by FIG. 7, the computational capability is generally illustrated by one or more processing unit(s) 710, and may also include one or more graphics processing units (GPUs) 715, either or both in communication with system memory 720. Note that that the processing unit(s) 710 of the simplified computing device 700 may be specialized microprocessors (such as a digital signal processor (DSP), a very long instruction word (VLIW) processor, a field-programmable gate array (FPGA), or other micro-controller) or can be conventional central processing units (CPUs) having one or more processing cores including, but not limited to, specialized GPU-based cores in a multi-core CPU.

In addition, the simplified computing device 700 of FIG. 7 may also include other components, such as, for example, a communications interface 730. The simplified computing device 700 of FIG. 7 may also include one or more conventional computer input devices 740 (e.g., pointing devices, keyboards, audio (e.g., voice) input devices, video input devices, haptic input devices, gesture recognition devices, devices for receiving wired or wireless data transmissions, and the like). The simplified computing device 700 of FIG. 7 may also include other optional components, such as, for example, one or more conventional computer output devices 750 (e.g., display device(s) 755, audio output devices, video output devices, devices for transmitting wired or wireless data transmissions, and the like). Note that typical communications interfaces 730, input devices 740, output devices 750, and storage devices 760 for general-purpose computers are well known to those skilled in the art, and will not be described in detail herein.

The simplified computing device 700 of FIG. 7 may also include a variety of computer-readable media. Computer-readable media can be any available media that can be accessed by the computer 700 via storage devices 760, and can include both volatile and nonvolatile media that is either removable 770 and/or non-removable 780, for storage of information such as computer-readable or computer-executable instructions, data structures, program modules, or other data. By way of example but not limitation, computer-readable media may include computer storage media and communication media. Computer storage media refers to tangible computer-readable or machine-readable media or storage devices such as digital versatile disks (DVDs), compact discs (CDs), floppy disks, tape drives, hard drives, optical drives, solid state memory devices, random access memory (RAM), read-only memory (ROM), electrically erasable programmable read-only memory (EEPROM), flash memory or other memory technology, magnetic cassettes, magnetic tapes, magnetic disk storage, or other magnetic storage devices, or any other device which can be used to store the desired information and which can be accessed by one or more computing devices.

Retention of information such as computer-readable or computer-executable instructions, data structures, program modules, and the like, can also be accomplished by using any of a variety of the aforementioned communication media to encode one or more modulated data signals or carrier waves, or other transport mechanisms or communications protocols, and can include any wired or wireless information delivery mechanism. Note that the terms “modulated data signal” or “carrier wave” generally refer to a signal that has one or more of its characteristics set or changed in such a manner as to encode information in the signal. For example, communication media can include wired media such as a wired network or direct-wired connection carrying one or more modulated data signals, and wireless media such as acoustic, radio frequency (RF), infrared, laser, and other wireless media for transmitting and/or receiving one or more modulated data signals or carrier waves. Combinations of any of the above should also be included within the scope of communication media.

Furthermore, software, programs, and/or computer program products embodying some or all of the various mapping technique embodiments described herein, or portions thereof, may be stored, received, transmitted, or read from any desired combination of computer-readable or machine-readable media or storage devices and communication media in the form of computer-executable instructions or other data structures.

Finally, the mapping technique embodiments described herein may be further described in the general context of computer-executable instructions, such as program modules, being executed by a computing device. Generally, program modules include routines, programs, objects, components, data structures, and the like, that perform particular tasks or implement particular abstract data types. The mapping technique embodiments may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Additionally, the aforementioned instructions may be implemented, in part or in whole, as hardware logic circuits, which may or may not include a processor.

Wherefore, what is claimed is:

1. A computer-implemented process for mapping an augmented reality experience to various environments, comprising:
using a computer to perform the following process actions:
inputting a three-dimensional data model that describes a scene of an environment;
inputting a description of the augmented reality experience, said description comprising a set of digital content that is to be mapped into the scene, and a set of constraints that defines attributes of the digital content when it is mapped into the scene;
analyzing the three-dimensional data model to detect affordances in the scene, said analysis generating a list of detected affordances; and
using the list of detected affordances and the set of constraints to solve for a mapping of the set of digital content into the scene that substantially satisfies the set of constraints.

2. The process of claim 1, wherein the digital content comprises one or more of:
one or more video-based virtual objects; or
one or more graphics-based virtual objects; or
one or more virtual audio sources.

3. The process of claim 1, wherein the environment is a real-world environment.

4. The process of claim 1, wherein the environment is a synthetic-world environment.

5. The process of claim 1, wherein the digital content comprises virtual objects and the attributes of the digital content comprise geometrical attributes comprising one or more of:
the position of one or more of the virtual objects in the scene; or
the rotational orientation of one or more of the virtual objects; or
the scale of one or more of the virtual objects; or
the up vector of one or more of the virtual objects.

6. The process of claim 1, wherein the digital content comprises virtual objects and the attributes of the digital content comprise non-geometrical attributes comprising one or more of:
the color of one or more of the virtual objects; or
the texture of one or more of the virtual objects; or
the mass of one or more of the virtual objects; or
the friction of one or more of the virtual objects.

7. The process of claim 1, wherein the set of constraints defines a geometrical relationship between a given item of digital content and one or more other items of digital content.

8. The process of claim 1, wherein the set of constraints defines a geometrical relationship between a given item of digital content and one or more objects that exist in the scene.

9. The process of claim 1, wherein the set of constraints defines a geometrical relationship between a given item of digital content and a user who perceives the augmented reality.

10. The process of claim 1, wherein the detected affordances comprise geometrical attributes of the scene comprising one or more of:
offering planes that exist in the scene; or
corners that exist in the scene; or
spatial volumes in the scene that are occupied by objects that exist in the scene.

11. The process of claim 1, wherein the detected affordances comprise non-geometrical attributes of the scene comprising one or more of:
known objects that are recognized in the scene; or
illuminated areas that exist in the scene; or
a pallet of colors that exists in the scene; or
a pallet of textures that exists in the scene.

12. The process of claim 1, wherein the process action of analyzing the three-dimensional data model to detect affordances in the scene comprises the actions of:
whenever the three-dimensional data model comprises a stream of depth map images of the scene, detecting affordances in the scene by using a depth map analysis method; and
whenever the three-dimensional data model comprises a stream of three-dimensional point cloud representations of the scene, detecting affordances in the scene by applying a Hough transform to the point cloud representations.

13. The process of claim 1, wherein, whenever the digital content comprises virtual objects and the set of constraints comprises a binding plane constraint for a given virtual object, the process action of using the list of detected affordances and the set of constraints to solve for a mapping of the set of digital content into the scene that substantially satisfies the set of constraints comprises the actions of:
selecting an offering plane from the list of detected affordances that substantially satisfies the binding plane constraint; and
assigning the binding plane of the virtual object to the selected offering plane.

14. The process of claim 1 wherein the process action of using the list of detected affordances and the set of constraints to solve for a mapping of the set of digital content into the scene that substantially satisfies the set of constraints comprises an action of using a theorem prover to solve for a mapping of the set of digital content into the scene that satisfies the set of constraints.

15. The process of claim 1, wherein a cost function is used to evaluate the degree to which a given mapping of the set of digital content into the scene satisfies the set of constraints, and the process action of using the list of detected affordances and the set of constraints to solve for a mapping of the set of digital content into the scene that substantially satisfies the set of constraints comprises an action of using a cost function optimization method to solve for a mapping of the set of digital content into the scene that minimizes the cost function by approximating the set of constraints.

16. The process of claim 15, wherein a pre-defined weight is assigned to each of the constraints in the set of constraints, and the cost function optimization method comprises either a simulated annealing method with a with a Metropolis-Hastings state-search step, or a Markov chain Monte Carlo sampler method.

17. The process of claim 1, further comprising one or more of the actions of:
storing the mapping of the set of digital content into the scene; or
using the mapping of the set of digital content into the scene to render an augmented version of the scene.

18. A system for mapping an augmented reality experience to changing environments, comprising:
a computing device; and
a computer program having program modules executable by the computing device, the computing device being directed by the program modules of the computer program to,
receive a three-dimensional data model that describes a scene of an environment as a function of time,
receive a description of the augmented reality experience, said description comprising a set of digital content that is to be mapped into the scene, and a set of constraints that defines attributes of the digital content when it is mapped into the scene,
analyze the three-dimensional data model to detect affordances in the scene, said analysis generating an original list of detected affordances,
use the original list of detected affordances and the set of constraints to solve for a mapping of the set of digital content into the scene that substantially satisfies the set of constraints, and
whenever changes occur in the scene,
re-analyze the three-dimensional data model to detect affordances in the changed scene, said re-analysis generating a revised list of detected affordances, and
use the revised list of detected affordances and the set of constraints to solve for a mapping of the set of digital content into the changed scene that substantially satisfies the set of constraints.

19. The system of claim 18, wherein the mapping of the set of digital content into the changed scene includes a re-mapping of just the attributes of the digital content that is affected by the differences between the original list of detected affordances and the revised list of detected affordances.

20. A computer-readable storage medium having computer-executable instructions stored thereon for mapping an augmented reality experience to various environments, said computer-executable instructions comprising:
inputting a three-dimensional data model that describes a scene of an environment;
inputting a description of the augmented reality experience, said description comprising a set of digital content that is to be mapped into the scene, and a set of constraints that defines attributes of the digital content when it is mapped into the scene, said attributes specifying the requisite behavior of the augmented reality experience when it is mapped into the scene, and said attributes comprising one or more of geometrical attributes of one or more items of the digital content, or non-geometrical attributes of one or more items of the digital content;
analyzing the three-dimensional data model to detect affordances in the scene, said analysis generating a list of detected affordances comprising one or more of geometrical attributes of the scene, or non-geometrical attributes of the scene; and
using the list of detected affordances and the set of constraints to solve for a mapping of the set of digital content into the scene that substantially satisfies the set of constraints.
